(19) United States
(12) Patent Application Publication
(10) Pub. No.: US 2017/0080896 A1
(43) Pub. Date: Mar. 23, 2017

(54) METHOD AND APPARATUS FOR SECURE PAIRING BASED ON FOB PRESENCE

(71) Applicant: FORD GLOBAL TECHNOLOGIES, LLC, Dearborn, MI (US)

(72) Inventors: Matthew Atwood WHITAKER, Novi, MI (US); Joseph Paul RORK, Plymouth, MI (US)

(21) Appl. No.: 14/858,183

(22) Filed: Sep. 18, 2015

(51) Int. Cl. B60R 25/01; H04W 12/06; H04W 76/02

(52) U.S. Cl. CPC B60R 25/01; H04W 76/023; H04W 12/06; G07C 2009/00769

(57) ABSTRACT

A system includes a processor configured to receive a request from a mobile device to utilize a vehicle resource. The processor is also configured to wirelessly identifying the presence of both a first vehicle key and a second vehicle key, being present at the same time and approve the request based on wireless identification of both the first key and the second key being simultaneously present.

### TECHNICAL FIELD

The illustrative embodiments generally relate to a method and apparatus for secure pairing.

### BACKGROUND

Utilization of mobile applications for various smartphone platforms, as well as mobile applications used to communicate with and control vehicle functions is a rapidly growing customer demand within the automotive field. Because vehicles have been provided with the capability to interface with smartphones, and to receive commands from and grant control of functions to a smartphone, security measures must be taken to prevent unauthorized access to the vehicle via a smartphone or other mobile device. Previous solutions have included direct on-screen access via a vehicle screen to pair a device, but this can permit a limited-time user (someone who borrows the vehicle, for example) to pair to the vehicle. Another previous option included some form of time delay following a request for verification purposes and to prevent immediate access to a party for whom access may not be desired. This can be onerous, however.

In another illustrative existing example, systems and methods may provide for determining a first proximity status of a first mobile device with respect to a vehicle, and determining a second proximity status of a second mobile device with respect to the vehicle. Additionally, an accessibility of one or more functions of the vehicle may be configured based at least in part on the first proximity status and the second proximity status. In one example, a policy associated with one or more of the first mobile device and the second mobile device may be identified, wherein the accessibility is configured further based on the policy.

In another existing example, an illustrative embodiment includes an automatic pairing system. The automatic pairing system includes a vehicle initialization module, a vehicle pairing module, and a triggering mechanism. The vehicle initialization module is loaded onto a vehicle abstraction device configured to interface with a vehicle. The vehicle pairing module is loaded on the vehicle abstraction device. The vehicle pairing module is configured to be launched by the vehicle initialization module. After being launched, the vehicle pairing module is configured to automatically communicate vehicle pairing data stored on the vehicle pairing module to establish one or more communication channels between the vehicle and a mobile device. The triggering mechanism is configured to trigger the vehicle initialization module to launch the vehicle pairing module.

### SUMMARY

In a first illustrative embodiment, a system includes a processor configured to receive a request from a mobile device to utilize a vehicle resource. The processor is also configured to wirelessly identifying the presence of both a first vehicle key and a second vehicle key, being present at the same time and approve the request based on wireless identification of both the first key and the second key being simultaneously present.

In a second illustrative embodiment, a computer-implemented method includes providing access to a vehicle resource by a vehicle processor in response to a request received by the vehicle processor from a mobile device if the vehicle wirelessly determines that both a first key and a second key are both present in a vehicle at the same time.

In a third illustrative embodiment, a system includes a mobile device processor configured to transmit a request to a vehicle processor to utilize a vehicle resource and receive authorization to access the vehicle resource from the vehicle processor based on the vehicle wirelessly determining that both a first key and a second key are both present in a vehicle at the same time.

### BRIEF DESCRIPTION OF THE DRAWINGS

FIG. 1 shows an illustrative vehicle computing system;

FIG. 2 shows the flow of an illustrative device or application pairing; and

FIG. 3 shows an illustrative pairing process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

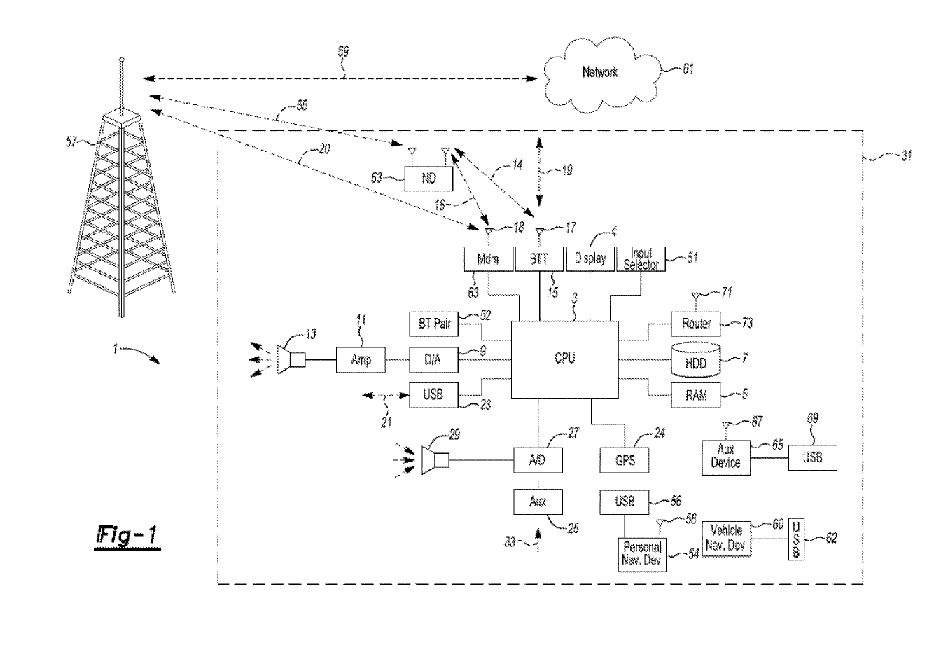

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

As previously noted, many present solutions for pairing a device/application/account to a vehicle leave something to be desired. Pairing through a vehicle interface may be convenient, but it may allow an unintended user to pair with a vehicle and gain control functionality. Pairing that requires a lengthy time-delay can both irritate authorized users and limit functionality for those users during the time delay. With the combination of vehicle feature control through smartphones and the increasingly common trend of temporarily renting vehicles or sharing a vehicle, an efficient way to pair a device or authorize an application to control a vehicle function is desirable.

In the illustrative embodiments, the presence of multiple authorized vehicle keys, in conjunction with a pairing request, allows pairing of a smart phone or authorization of an application. Since presumably only a vehicle owner or authorized requestor will have access to more than one key, this can provide an efficient mechanism for verifying a request, while at the same time limiting the request to those parties most likely to be authorized to make the request.

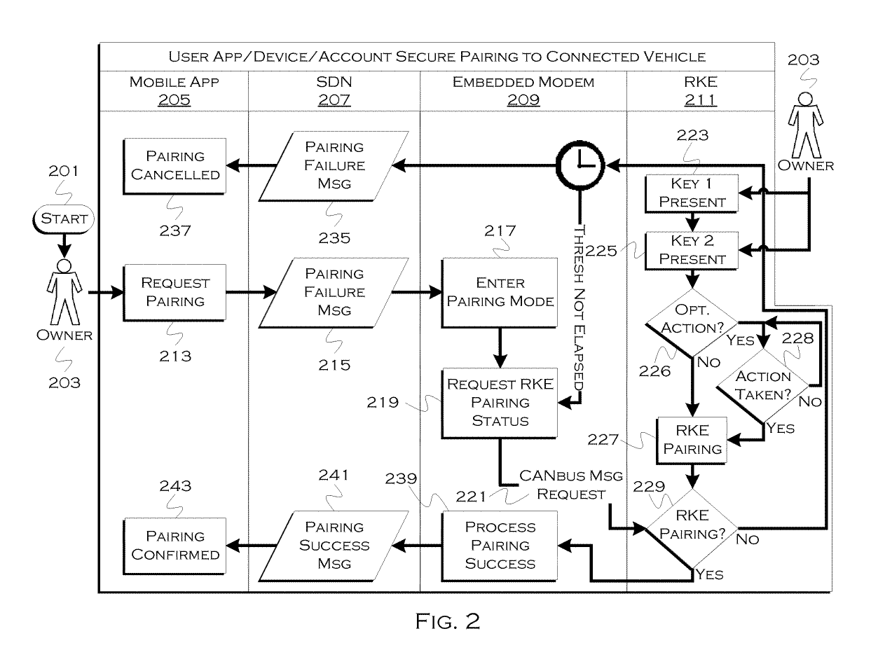

FIG. 2 shows the flow of an illustrative device or application pairing. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, there are four acting entities involved in the pairing. Specifically, these are a mobile application requesting authorization 205 or device requesting pairing, a service delivery network (SDN) 207, an embedded modem 209 and a remote keyless entry system (or other vehicle keys) 211.

Here, the owner 201 is requesting authorization for a mobile application to receive approval to control a vehicle function. Additionally or alternatively, a mobile device pairing request could be initiated. The owner 203 first utilizes the mobile device (here an application on the device) to request pairing 213. The request 215 is sent to the SDN, where a pairing mode is activated based on the request 217. In this example, the system then queries the vehicle to determine if two keys are present, which indicates a high likelihood of an owner bringing two keys into the vehicle in order to facilitate the pairing request, since the keys will likely not both be present otherwise.

The owner, subsequent to requesting the pairing, can bring both a first key 223 and a second key 225 into the vehicle. In this example, the keys are provided with RF or other wireless communication capability, which allows the vehicle to recognize the presence of both keys within a certain proximity, and/or as being in the vehicle.

Also, it is possible that some action may need to be taken to prevent inadvertent pairing modes when both keys just happen to be present. In such a configuration, the process may determine if some additional action is needed 226. If no action is needed (the presence alone suffices) the process will continue 227 on the basis of both fobs being present. Otherwise, the process may determine if some designated action has been taken 228. This can include, but is not limited to: pressing a pre-determined key or sequence on one or both of the fobs; placing one key in a specific pre-determined location—e.g., near a specific antenna and measure based on signal strength; acknowledging pairing opportunity in center stack by clicking a modal or non-modal button on interface; pressing a specific sequence of keys in the vehicle; performing a fob utilization sequence—e.g., without limitation unlock, unlock, start, stop, unlock; etc. Upon completing the required process the car could acknowledge pairing status via text alert, audio message, horn-sounding, flashing of lights, icon on dash.

If both keys are present in the vehicle, the vehicle will enter an RKE pairing mode 227, which is confirmed 229 for the requesting system. Once both keys are present and the RKE pairing mode has been entered, the process will complete the pairing 239 and a success message may result 241. Pairing can then be confirmed on the mobile device or at the application requesting the pairing 243.

A timeout 231 can be used to help prevent inadvertent pairing. If a pairing request was entered one day, and two keys were brought into a vehicle another day, the timeout prevents accidentally approving the pairing request based on a condition met outside the time window. An appropriately short window can be applied to the timeout such that the multiple-key startups are done intentionally within the window. Lapsing of the time window 235 can cause the pairing process to exit and cancel the pairing of the device 237.

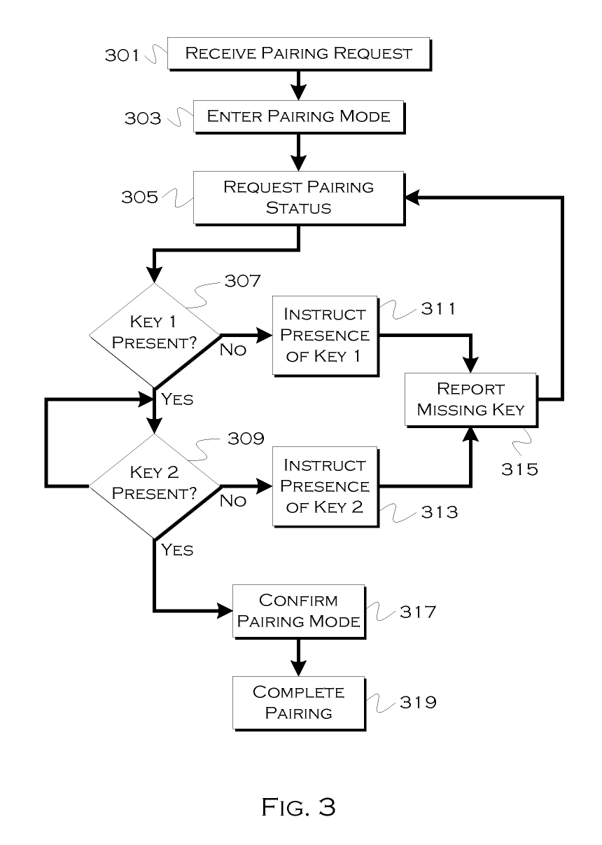

FIG. 3 shows an illustrative pairing process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

This is an example of a vehicle or cloud-based process that can run to determine if the pairing request and required follow-up (in this example, the two key start process) has be performed in the appropriate time period.

The process receives a pairing request 301. This could be a request sent to the vehicle directly, or a request sent to the cloud for authorization of a device, application or user account (e.g., without limitation, a request to utilize vehicle functionality using the device, application or account). The process then enters a pairing mode 303, which starts a timeout clock in this example and begins to look for an approved pairing status indicating the presence of both keys in the vehicle. The paring status is requested from the vehicle 305. If a first key is present in the vehicle 307, the process will check for a second key 309. If either the first or second keys are not present, an appropriate message 311, 313 indicating which key is missing and instructing presence of the missing key can be delivered to a user. The missing key is also reported back to the requesting process 315, so that the requesting user/process knows that the pairing mode is not yet enabled and/or why the enablement failed.

In this example, so that the user knows the protocol for pairing and can respond to failed attempts, the process instructs the user to bring both keys into the vehicle, or, more specifically in this example, the process recognizes that a key is missing and instructs the user to bring the missing key into the vehicle.

Once both keys are present in the vehicle, the process confirms that the pairing mode has been entered 317. At any point during this process, if the timeout expires before both keys are present, the process can exit. The pairing mode, once enabled by the presence of both keys, allows the user to complete the requested pairing 319.

In at least one example, a remote server can receive indicia from the vehicle that both keys are present (or one indicia for each key) and facilitate a pairing state based on receipt of the indicia within a time window. The indicia may also be utilized for verification based on receipt of the indicia (if received individually for each key) in some proximity to each other (e.g., both are received within a few seconds, or, for example, if key_2 is missing, once key_2 indicia is received key_1 indicia (previously received) is re-requested to confirm simultaneous presence of both keys.

Through use of the multiple key presence system described herein, quick pairing can be obtained in a manner that should be relatively simple for an authorized vehicle owner or user that has access to all keys. Improper pairing can be avoided, and the authorized user can proceed in a fairly simple manner when a proper request is sent.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a request from a mobile device to utilize a vehicle resource;
wirelessly identify simultaneous presence of both a first vehicle key and a second vehicle key; and
approve the request based on the wireless identification.

2. The system of claim 1, wherein the processor is further configured to:
identify the presence of both the first key and second key within a predetermined time window; and
approve the request based on the determination that both keys are present simultaneously, within the predetermined time window.

3. The system of claim 1, wherein the processor is further configured to:
instruct a user to bring both the first key and the second key into the vehicle.

4. The system of claim 3, wherein the processor instructs the user by sending an instruction to the mobile device for display.

5. The system of claim 4, wherein the instruction is displayed on a vehicle interface.

6. The system of claim 1, wherein the request includes a pairing request.

7. The system of claim 1, wherein the request includes a request to control a vehicle function.

8. The system of claim 1, wherein the request includes a request to utilize a vehicle resource.

9. The system of claim 1, wherein the processor is remote from a vehicle and the identifications of the first key and second key being simultaneously present are based on identifiers associated with the first key and second key, which identifiers are received by the processor from the vehicle.

10. A computer-implemented method comprising:
providing access to a vehicle resource by a vehicle processor in response to a request received by the vehicle processor from a mobile device if the vehicle wirelessly determines that both a first key and a second key are concurrently present in a vehicle.

11. The method of claim 10, the predetermined criteria comprising:
determining that the first key and second key are simultaneously present within a predetermined time window of each other.

12. The method of claim 10, further comprising:
generating an instruction for a user to bring both the first key and second key into the vehicle concurrently.

13. The method of claim 10, further comprising identifying and transmitting indicia indicating presence of the first key and the second key, the indicia transmitted by the vehicle and received by a computer remote from the vehicle.

14. A system comprising:
a mobile device processor configured to:
transmit a request to a vehicle processor to utilize a vehicle resource; and
receive authorization to access the vehicle resource from the vehicle processor based on the vehicle wirelessly determining that both a first key and a second key are both present in a vehicle at the same time.

15. The system of claim 14, the mobile device processor further configured to control a user interface to display instructions for bringing both the first key and the second key into the vehicle at the same time.

16. The system of claim 15 wherein the mobile device processor communicates with a server remote from the vehicle to receive authorization.

17. The system of claim 15, wherein the predetermined vehicle criteria includes determining that both the first key and second key are within the vehicle within a predefined time window of each other.

18. The system of claim 15, utilizing the vehicle resource including control of a vehicle system via the mobile device.

19. The system of claim 15, utilizing the vehicle resource including utilization of a vehicle input or output.

20. The system of claim 15, utilizing the vehicle resource including requesting information from a vehicle system.
